(19) United States
(12) Patent Application Publication
(10) Pub. No.: US 2026/0036801 A1
(43) Pub. Date: Feb. 5, 2026

(54) MICROSCOPE DEVICE AND FLAT REVOLVER

(71) Applicant: NIKON CORPORATION, Tokyo (JP)

(72) Inventor: Toshiya SUZUKI, Tokyo (JP)

(73) Assignee: NIKON CORPORATION, Tokyo (JP)

(21) Appl. No.: 19/352,875

(22) Filed: Oct. 8, 2025

Related U.S. Application Data
(63) Continuation of application No. PCT/JP2024/012353, filed on Mar. 27, 2024.

(30) Foreign Application Priority Data
Apr. 11, 2023 (JP) 2023-064401

(51) Int. Cl. G02B 21/24; G02B 7/09; G02B 21/02; G02B 21/26; G02B 21/34

(52) U.S. Cl. CPC G02B 21/241; G02B 7/09; G02B 21/025; G02B 21/248; G02B 21/26; G02B 21/34

(57) ABSTRACT

A flat revolver mountable on a microscope device holds a plurality of objectives having different magnifications, the same design value of parfocal distance, and different working distances so that optical axes of the objectives are parallel, and has a recessed structure in which with respect to a region where a first objective among the plurality of objectives is held, a region where a second objective different from the first objective is held is recessed by a predetermined distance such that the tip of the first objective does not interfere with a structure on a stage of the microscope device at magnification switching operation for switching an observation magnification of an image of a specimen in the microscope device and focusing operation for an object of observation.

### CROSS-REFERENCE TO RELATED APPLICATIONS

This application is a continuation of International Patent Application No. PCT/JP2024/012353 filed Mar. 27, 2024, which claims priority from Japanese Patent Application No. 2023-064401 filed Apr. 11, 2023, which are incorporated herein by reference.

### FIELD

The present invention relates to a microscope device and a flat revolver.

### BACKGROUND

In general, a revolver that holds a plurality of objectives having different magnifications and the same design value of parfocal distance in a microscope holds the objectives so that their optical axes are inclined relative to each other to avoid interference between the objectives and the stage or specimen. On the other hand, some microscopes have a revolver that holds a plurality of objectives so that their optical axes are parallel. Such a revolver is also referred to as a flat revolver, and has the advantages of being able to be installed in a small space, making a microscope compact, and having a simple parts structure, reducing processing costs. However, such a revolver has the problem that, depending on the working distance of each objective and the shapes of the stage and specimen, an objective that is not aligned with the optical axis of the microscope may come into contact with the stage or specimen at focusing operation for an objective.

Japanese Unexamined Patent Publication No. 2006-337643 (hereinafter “Patent Literature 1”) describes an objective support including a holder to which an objective is fixed and a ring supporting the holder via a compression spring. According to the objective support of Patent Literature 1, the objective can be retracted to where interference with the stage is avoided, by pressing the holder against the compression spring.

### SUMMARY

A microscope device of an embodiment of the present invention is a microscope device on which a revolver is mountable; the revolver holds a plurality of objectives having different magnifications, the same design value of parfocal distance, and different working distances so that optical axes of the objectives are parallel. The microscope device includes a drive unit configured to perform, at switching an observation magnification of an image of a specimen, magnification switching operation for switching the observation magnification of the specimen by moving the revolver in a plane perpendicular to the optical axes to change objectives used for observing the specimen among the plurality of objectives, and focusing operation for focusing by moving at least one of the revolver and a stage where the specimen is placed to change the distance between each objective and a specimen surface of the specimen. In a mounting surface capable of holding the plurality of objectives, the revolver to be mounted has a recessed structure in which with respect to a region where a first objective among the plurality of objectives is held, a region where a second objective different from the first objective is held is recessed by a predetermined distance such that the tip of the first objective does not interfere with a structure on the stage at the magnification switching operation and the focusing operation.

A flat revolver of an embodiment of the present invention is a flat revolver mountable on a microscope device and configured to hold a plurality of objectives having different magnifications, the same design value of parfocal distance, and different working distances so that optical axes of the objectives are parallel. The flat revolver has a recessed structure in which with respect to a region where a first objective among the plurality of objectives is held, a region where a second objective different from the first objective is held is recessed by a predetermined distance such that the tip of the first objective does not interfere with a structure on a stage of the microscope device at magnification switching operation for switching an observation magnification of an image of a specimen in the microscope device and focusing operation for an object of observation.

### BRIEF DESCRIPTION OF DRAWINGS

FIG. 1 schematically shows the configuration of an observation system S.

FIG. 2 is a perspective view of a microscope device 1.

FIG. 3 is a perspective view of objectives 13 and a revolver 14.

FIG. 4 is a schematic diagram for explaining an example of the positional relationship between the objectives 13.

FIG. 5 is a schematic diagram for explaining an example of the positional relationship between the objectives 13.

FIG. 6 is an exemplary functional block diagram of the microscope device 1.

FIG. 7 is a flowchart showing an example of the flow of a switching process.

FIG. 8 is an exemplary functional block diagram of a microscope device 2.

FIG. 9 is a flowchart showing an example of the flow of a switching process.

### DESCRIPTION OF EMBODIMENTS

Various embodiments of the present invention will now be described with reference to the attached drawings. It should be noted that the technical scope of the present invention is not limited to embodiments thereof and covers the invention described in the claims and equivalents thereof.

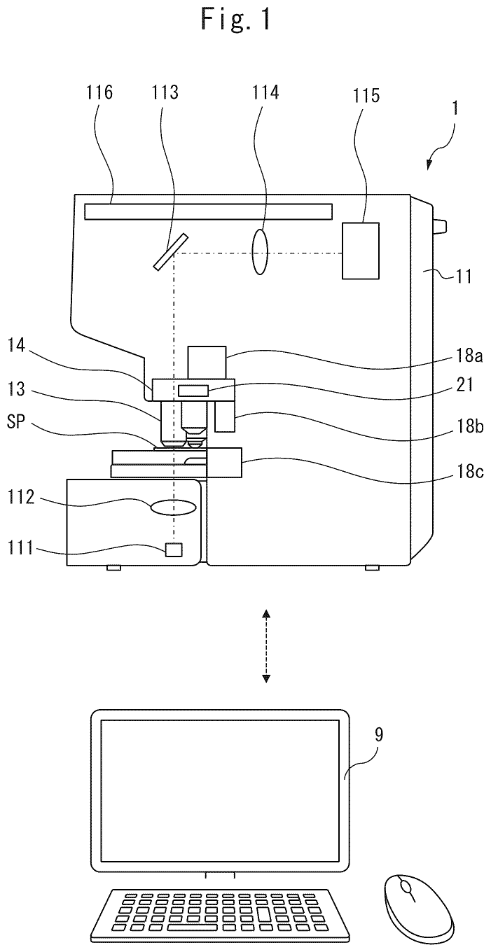

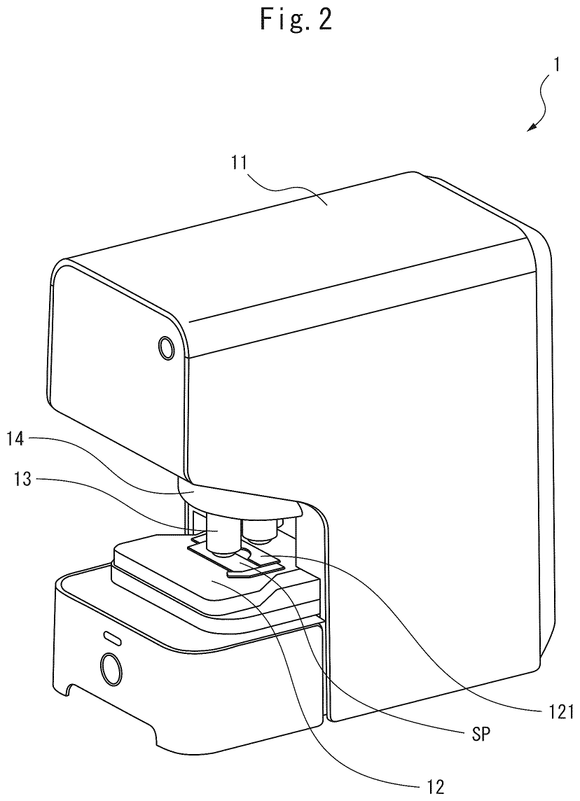

FIG. 1 schematically shows the configuration of an observation system S of an embodiment of the present invention; FIG. 2 is a perspective view of a microscope device 1. The observation system S includes a microscope device 1 and a display terminal 9. The microscope device 1 and the display terminal 9 are connected via a predetermined interface so that they can transmit and receive data. The microscope device 1 generates a captured image including a specimen image, and transmits the image to the display terminal 9. The microscope device 1 includes a personal computer (PC) constituting a control unit 116, and communicates with the display terminal 9 (a mouse, a keyboard, and a display). The display receives and shows an image outputted from the microscope device 1.

The microscope device 1 is an upright microscope, and captures a specimen to output a captured image including a specimen image. The microscope device 1 includes a housing 11, a stage 12, a plurality of objectives 13, and a revolver 14.

The housing 11 has a substantially rectangular parallelepiped shape in the side surface of which a space for placing a specimen SP is formed, and houses components of the microscope device 1. For example, as shown in FIG. 1, the housing 11 houses a power source, a light source 111 and an illumination optical system (e.g., a condenser lens 112) for irradiating a specimen SP with illumination light, an optical system or the like for forming a specimen image (e.g., the objectives 13, a mirror 113, a second objective 114), and a digital camera including an imaging device 115. In the following, the optical system of the microscope device 1 is assumed to be an imaging optical system for forming an image on the imaging device 115 to generate a captured image, but may be an observation optical system for forming an image on a user's retina through an eyepiece. The housing 11 also includes the control unit 116 housing a storage unit 15, a communication unit 16, an operation unit 17, a drive unit 18, and a processing unit 19 described below.

The stage 12 is a component for placing a specimen SP, and is disposed in the space formed in the side surface of the housing 11. A specimen SP is placed on the upper surface of the stage 12. As shown in FIG. 2, the stage 12 includes a specimen holder 121 for fixing a specimen SP placed on the upper surface. The stage 12 is moved horizontally by the drive unit 18 described below.

The objectives 13 are disposed above the stage 12, and have the same design value of parfocal distance. In other words, the design value of the distance from the shoulder to the focus position of each of the objectives 13 is the same. The objectives 13 have different magnifications.

The revolver 14 is disposed above the stage 12, and holds each objective 13 so that the optical axes of the objectives 13 are parallel, and that the positional relationship between the objectives 13 is fixed. In other words, the revolver 14 does not include a mechanism for changing the positional relationship between the objectives 13. The revolver 14 is rotated relative to the housing 11 around an axis of rotation parallel to the optical axes of the objectives 13 by the drive unit 18 described below. The revolver 14 switches the magnification (observation magnification) of a specimen image by rotating so that the optical axis of one of the objectives 13 is aligned with that of the optical system of the microscope device 1. To focus, the revolver 14 is also moved vertically by the drive unit 18 described below.

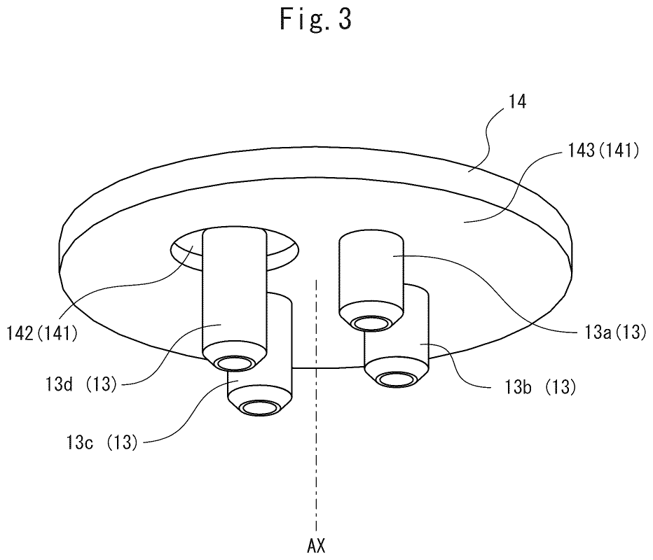

FIG. 3 is a perspective view of the objectives 13 and the revolver 14. The revolver 14 holds a first objective 13a, a second objective 13b, a third objective 13c, and a fourth objective 13d, which are the objectives 13. The objectives 13 are disposed so that their optical axes are on a circle centered at the axis AX of rotation of the revolver 14 parallel to the optical axis of each objective 13. The revolver 14 rotates around the axis AX of rotation to move the objectives 13 in a plane perpendicular to the optical axis of each objective 13, thereby aligning the optical axis of one of the objectives 13 with that of the optical system.

The revolver 14 has a mounting surface 141 connected with each objective 13 to fix the positional relationship between the objectives 13 and to hold each objective 13. For example, the mounting surface 141 has internal thread structures, and holds each objective 13 by each internal thread structure on the mounting surface 141 being screwed to an external thread structure projecting from the shoulder of each objective 13. The mounting surface 141 is formed perpendicularly to the optical axis of each objective 13.

The plurality of objectives 13 includes objectives 13 having different working distances. In the example shown in FIG. 3, the working distances of the first objective 13a (e.g., 4-fold magnification), the second objective 13b (e.g., 10-fold magnification), the third objective 13c (e.g., 20-fold magnification), and the fourth objective 13d (e.g., 40-fold magnification) differ from each other and decrease in this order. In other words, the lengths of the first objective 13a, the second objective 13b, the third objective 13c, and the fourth objective 13d increase in this order. The length of each objective 13 is the distance from the shoulder to the tip of the objective 13.

The mounting surface 141 of the revolver 14 holds the objectives 13 so that the shoulder of one of the objectives 13 is farther from a specimen surface than the shoulders of the other objectives 13. In the example shown in FIG. 3, a region 142 in the mounting surface 141 connected with the fourth objective 13d is recessed with respect to a region 143 in the mounting surface 141 connected with the first objective 13a, the second objective 13b, and the third objective 13c. In other words, the revolver 14 has a structure in which the region 142 in the mounting surface 141 where the fourth objective 13d is held is recessed with respect to the region 143 in the mounting surface 141 where the first objective 13a, the second objective 13b, and the third objective 13c are held. Thus the revolver 14 holds the objectives 13 so that the shoulder of the fourth objective 13d is farther from the specimen surface than the shoulders of the first objective 13a, the second objective 13b, and the third objective 13c.

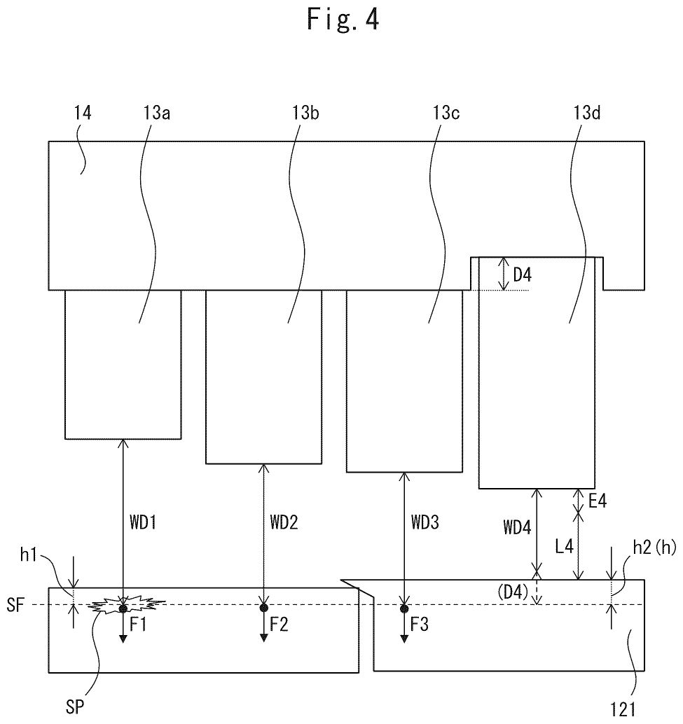

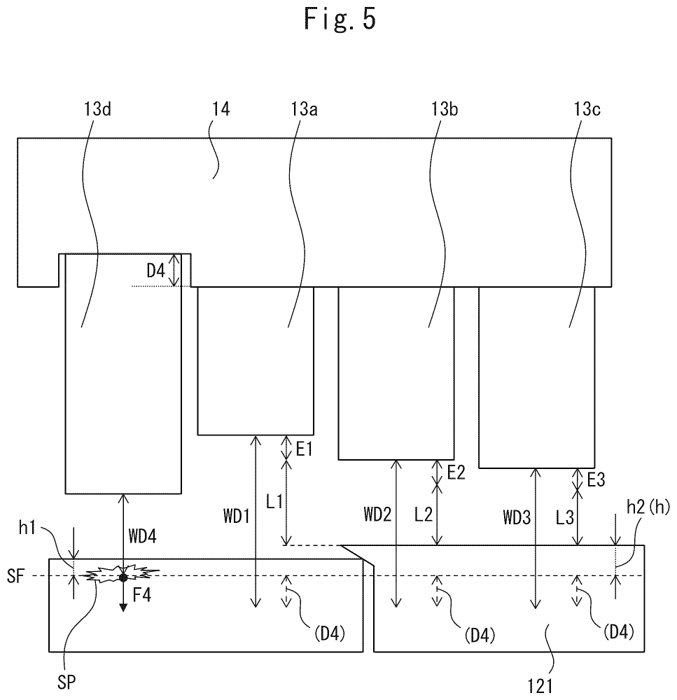

FIGS. 4 and 5 are schematic diagrams for explaining examples of the positional relationship between the objectives 13. Although the objectives 13 are disposed so that their optical axes are on a circle centered at the axis AX of rotation of the revolver 14, as described above, FIGS. 4 and 5 show the optical axes of the objectives 13 on a straight line for ease of viewing.

In the examples shown in FIGS. 4 and 5, the revolver 14 holds the objectives 13 so that the shoulder of the fourth objective 13d is farther from a specimen surface SF by a predetermined distance D4 (described below in detail) than the shoulders of the first to third objectives 13a to 13c. Further, the revolver 14 holds the objectives 13 so that the shoulders of the other objectives 13a to 13c are on the same plane.

The predetermined distance D4 is set so that the fourth objective 13d does not interfere with a portion projecting from the specimen surface SF of a structure on the stage 12, such as a cover member of a specimen SP or the specimen holder 121, in focusing operation for the first to third objectives 13a to 13c. Further, the predetermined distance D4 is set so that the other objectives 13a to 13c do not interfere with a portion projecting from the specimen surface SF of the cover member of the specimen SP on the stage 12 (e.g., a cover glass or an embedding agent) or the specimen holder 121 in focusing operation for the fourth objective 13d.

In FIG. 4, the design focus positions of the first to third objectives 13a to 13c coincide with the specimen surface SF. As the tip of the fourth objective 13d is closer to the specimen surface SF, the fourth objective 13d is more likely to interfere with the cover member of the specimen SP or the specimen holder 121 when the stage 12 and the revolver 14 approach in focusing operation for the other objectives 13a to 13c. At this time, a sufficiently large predetermined distance D4 keeps the tip of the fourth objective 13d away from the specimen surface SF and avoids the interference. Thus the predetermined distance D4 is set to a distance exceeding a predetermined lower limit so that the fourth objective 13d may not interfere with the specimen SP or the specimen holder 121.

In FIG. 5, the design focus position of the fourth objective 13d coincides with the specimen surface SF. As the tips of the other objectives 13a to 13c are closer to the specimen surface SF, the other objectives 13a to 13c are more likely to interfere with the cover member of the specimen SP or the specimen holder 121 when the stage 12 and the revolver 14 approach in focusing operation for the fourth objective 13d. At this time, a sufficiently small predetermined distance D4 keeps the tips of the first to third objectives 13a to 13c away from the specimen surface SF and avoids the interference. Thus the predetermined distance D4 is set to a distance less than a predetermined upper limit so that the other objectives 13a to 13c may not interfere with the specimen SP or the specimen holder 121.

As described above, the working distances of the first to fourth objectives 13a to 13d are denoted by WD1 to WD4, respectively. Distances by which the design focus positions of the first to fourth objectives 13a to 13d are movable from the specimen surface SF toward the stage 12 in focusing operation for each objective 13 are denoted by F1 to F4, respectively. In other words, the design focus positions of the first to fourth objectives 13a to 13d can move below the specimen surface SF by the distances F1 to F4, respectively, in focusing operation. The distances F1 to F4 may be the same distance or different distances. The values of F1 to F4 are set in consideration of the intended use so that focusing operation is possible even when the actual focus positions of the first to fourth objectives 13a to 13d differ from the design focus positions or when observation of the area below the specimen surface SF is desired, and that the objectives are not too long and do not hit the specimen holder or specimen.

Further, tolerances for the working distances of the first to fourth objectives 13a to 13d are denoted by E1 to E4, respectively. The tolerances E1 to E4 for the working distances are errors by which the effective working distances of the objectives 13a to 13d vary. For example, the tolerances E1 to E4 for the working distances include errors caused by the design error of parfocal distance of each objective and the design errors of the heights of the stage 12, the mounting surface 141 of the revolver 14, and the specimen holder 121. Further, the greater of the height h1 of the specimen SP (including a cover member) and the height h2 of the specimen holder 121 with respect to the specimen surface SF is denoted as h. The height h1 of the specimen SP includes, for example, the height of a coating agent applied to the cover member to fix the cover member. Since the height h2 of the specimen holder 121 is greater than the height h1 of the specimen SP in the examples shown in FIGS. 4 and 5, the height h2 of the specimen holder 121 will be denoted as h below. However, an objective whose optical axis is aligned with the optical axis of the optical system of the microscope device 1 and the other objectives may interfere with different portions when the objectives and the stage are moved horizontally and vertically relative to each other by amounts required for the microscope device. Thus, in FIGS. 4 and 5, h denotes the height of a portion that may interfere with the other objectives.

As shown in FIG. 4, when the design focus positions of the first to third objectives 13a to 13c coincide with the specimen surface SF, the minimum of the actual distance L4 from the tip of the fourth objective 13d to the specimen holder 121 is a distance (L4=WD4+D4−E4−h) that is the tolerance E4 for the working distance of the fourth objective 13d and the height h of the specimen holder 121 with respect to the specimen surface SF subtracted from the sum of the working distance WD4 of the fourth objective 13d and the predetermined distance D4. When focusing operation for the first to third objectives 13a to 13c is performed in this state, the distance between the stage 12 and the revolver 14 is reduced by the distances F1 to F3, respectively, at the maximum. When the minimum of the actual distance L4 from the tip of the fourth objective 13d to the specimen holder 121 is greater than the distances F1 to F3, the interference of the fourth objective 13d is avoided by design (L4>F1, L4>F2, L4>F3). Thus the interference of the fourth objective 13d is avoided when the predetermined distance D4 satisfies the following expressions.

$$\begin{matrix}D 4 > ( E 4 + F 1 + h ) - WD 4 \\ D 4 > ( E 4 + F 2 + h ) - WD 4 \\ D 4 > ( E 4 + F 3 + h ) - WD 4\end{matrix} \qquad [ Expression 1 ]$$

In other words, the lower limit of the predetermined distance D4 is set based on the working distance WD4 of the fourth objective 13d and first adjustment values that are the sums of the tolerance E4 for the working distance of the fourth objective 13d, the distances F1 to F3 by which the design focus positions of the first to third objectives 13a to 13c are movable toward the stage beyond the specimen surface SF, and the height h of a portion of the specimen holder 121 projecting from the specimen surface SF.

As shown in FIG. 5, when the design focus position of the fourth objective 13d coincides with the specimen surface SF, the minima of the actual distances (L1, L2, and L3) from the tips of the first to third objectives 13a to 13c to the specimen holder 121 are distances (L1=WD1−D4−E1−h, L2=WD2−D4−E2−h, L3=WD3−D4−E3−h) that are the sums of the predetermined distance D4, the tolerances E1 to E3 for the working distances of the first to third objectives 13a to 13c, and the height h of the specimen holder 121 with respect to the specimen surface SF subtracted from the working distances WD1 to WD3 of the first to third objectives 13a to 13c, respectively. When focusing operation for the fourth objective 13d is performed in this state, the distance between the stage 12 and the revolver 14 is reduced by the distance F4 at the maximum. When the distances (L1 to L3) from the tips of the first to third objectives 13a to 13c to the specimen holder 121 are greater than the distance F4, the interference of the first to third objectives 13a to 13c is avoided by design (L1>F4, L2>F4, L3>F4). Thus the interference of the first to third objectives 13a to 13c is avoided when the predetermined distance D4 satisfies the following expressions.

$$\begin{matrix}D 4 < WD 1 - ( B 1 + F 4 + h ) \\ D 4 < WD 2 - ( E 2 + F 4 + h ) \\ D 4 < WD 3 - ( B 3 + F 4 + h )\end{matrix} \qquad [ Expression 2 ]$$

In other words, the upper limit of the predetermined distance D4 is set based on the working distances WD1 to WD3 of the first to third objectives 13a to 13c and second adjustment values that are the sums of the tolerances E1 to E3 for the working distances of the first to third objectives 13a to 13c, the distance F4 by which the design focus position of the fourth objective 13d is movable toward the stage beyond the specimen surface SF, and the height h of the portion of the specimen holder 121 projecting from the specimen surface SF.

In view of the above, the predetermined distance D4 is set to satisfy the following expressions.

$$\begin{matrix}( E 4 + F 1 + h ) - WD 4 < D 4 < WD 1 - ( E 1 + F 4 + h ) \\ ( E 4 + F 2 + h ) - WD 4 < D 4 < WD 2 - ( E 2 + F 4 + h ) \\ ( E 4 + F 3 + h ) - WD 4 < D 4 < WD 3 - ( E 3 + F 4 + h )\end{matrix} \qquad [ Expression 3 ]$$

In other words, the lower limit of the predetermined distance D4 is the largest of the values that are the working distance WD4 of the fourth objective 13d subtracted from the first adjustment values for the first to third objectives 13a to 13c, respectively. The upper limit of the predetermined distance D4 is the smallest of the second adjustment values subtracted from the working distances WD1 to WD3 of the first to third objectives 13a to 13c, respectively.

Since the shoulder of the fourth objective 13d is disposed farther from the specimen surface SF than the shoulders of the other objectives 13a to 13c, the design focus position of the fourth objective 13d are not on the same plane as the design focus positions of the other objectives 13a to 13c. Thus, when the magnification of the specimen image switches from the magnification of one of the first to third objectives 13a to 13c to that of the fourth objective 13d in magnification switching process described below, the microscope device 1 needs control operation for bringing the revolver 14 (the focus position of the fourth objective 13d) and the specimen surface SF closer together.

Generalization of the above-described lower and upper limits of the predetermined distance yields the following expression.

$$( Eb + Fa + h ) - WDb < Db < WDa - ( Ea + Fb + h ) \qquad [ Expression 4 ]$$

More specifically, the plurality of objectives is numbered 1, 2, 3, . . . , in descending order of working distance. Of the plurality of objectives, an objective having a longer working distance is referred to as an objective a, and an objective having a shorter working distance as an objective b. The predetermined distance Db of the objective b having a shorter working distance is set so that (WDb+Db)−(Eb+Fa+h)>0, in case the tip of the objective b having a shorter working distance hits a portion projecting from the specimen surface (WDb−(Eb+Fa+h)<0) at focusing operation for the objective a having a longer working distance. The predetermined distance Db of the objective b having a shorter working distance is also set so that (WDa−Db)−(Ea+Fb+h)>0 to avoid the tip of the objective a having a longer working distance hitting the portion projecting from the specimen surface (WDa−(Ea+Fb+h)<0) when the objective b having a shorter working distance is in focus.

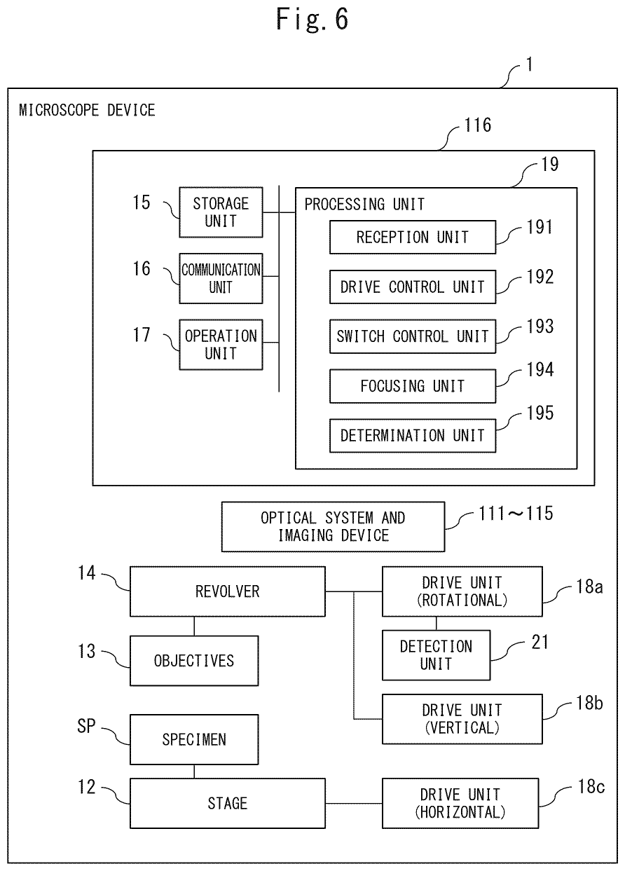

FIG. 6 is a functional block diagram of the microscope device 1. The microscope device 1 further includes a storage unit 15, a communication unit 16, an operation unit 17, a drive unit 18, and a processing unit 19. The storage unit 15, the communication unit 16, the operation unit 17, and the processing unit 19 are included in the control unit 116 housed in the housing 11.

The storage unit 15 is configured to store data and programs, and includes memories, such as a read-only memory (ROM) and a random access memory (RAM). The storage unit 15 stores an operating system program, a driver program, an application program, and other data used for processing by the processing unit 19. The programs are installed in the storage unit 15 from a computer-readable and non-transitory portable storage medium, such as a compact disc read-only memory (CD-ROM) or a digital versatile disc read-only memory (DVD-ROM).

The communication unit 16 is configured to enable the microscope device 1 to communicate with the display terminal 9, and includes an interface circuit, which is, for example, a communication interface circuit for a wireless local area network (LAN), a wired LAN, or the like. The interface circuit may be a serial interface circuit, such as Recommended Standard 232 (RS-232) or Universal Serial Bus (USB), or an image interface circuit, such as High-Definition Media Interface (HDMI) (registered trademark). The communication unit 16 outputs data of captured images provided from the processing unit 19 to the display terminal 9.

The operation unit 17 is configured to accept operation on the microscope device 1, and receives control signals from an external terminal operable from outside the housing 11, a button, a lever, a knob, or the like. The operation unit 17 accepts operation for moving the revolver 14 in the Z direction or moving the stage 12 in the X and Y directions to change the distance between the objectives 13a to 13d and a specimen surface SF or the observation position on the specimen surface SF. The operation unit 17 also accepts operation for rotating the revolver 14 to switch the magnification of the specimen image. The operation unit 17 generates a signal depending on the accepted operation and provides the signal to the processing unit 19.

The drive unit 18 shown in FIG. 1 is a drive source (18b) for moving the revolver 14 in the Z direction, a drive source (18a) for rotating the revolver 14 to switch the magnification of a specimen image, and a drive source (18c) for moving the stage 12 in the X and Y directions, and includes a motor and an actuator connected to the stage 12 and the revolver 14, respectively. Based on a drive signal provided from the processing unit 19, the drive unit 18 rotates the revolver 14, moves the revolver 14 vertically, or moves the stage 12 horizontally. Based on a switch signal provided from the processing unit 19, the drive unit 18 rotates the revolver 14 so that the optical axis of one of the objectives 13 is aligned with that of the optical system of the microscope device 1. Whether the stage 12 or the revolver 14 is driven in the X, Y, and Z directions can be determined on the basis of design-related reasons.

The revolver 14 and the stage 12 may be provided with a detection unit that detects their operating states, and information from the detection unit may be reflected on processing executed by the processing unit 19. A detection unit 21 shown in FIG. 1 is configured to detect an objective whose optical axis is aligned with the optical axis of the optical system of the microscope device 1 among the objectives 13, and includes a sensor. The sensor is, for example, an encoder that detects the rotation angle of the revolver 14. The sensor may be a magnetic proximity sensor that calculates the distance to each objective 13. The detection unit 21 generates a signal indicating information for identifying an objective whose optical axis is aligned with the optical axis of the optical system of the microscope device 1, and provides the signal to the processing unit 19.

The processing unit 19 is configured to centrally control the operation of the microscope device 1, and includes one or more processors and peripheral circuits. The processing unit 19 includes, for example, a central processing unit (CPU). The processing unit 19 may include a large-scale integration (LSI), an application specific integrated circuit (ASIC), or the like. The processing unit 19 executes various processes based on programs stored in the storage unit 15 and information from the detection unit.

The processing unit 19 includes a reception unit 191, a drive control unit 192, a switch control unit 193, a focusing unit 194, and a determination unit 195. These units are functional modules achieved by a program executed by the processing unit 19, or may be implemented in the microscope device 1 as dedicated processing circuits.

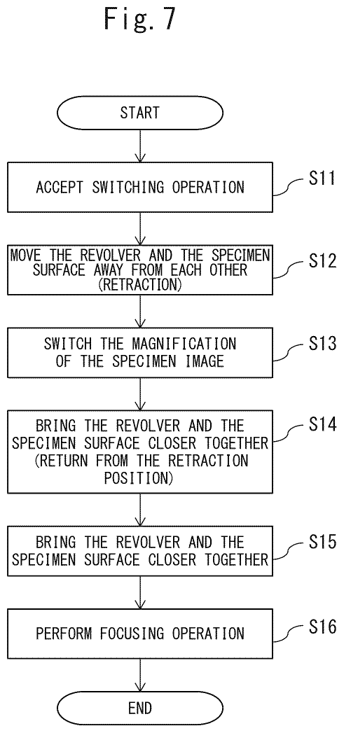

FIG. 7 is a flowchart showing an example of the flow of a switching process performed by the microscope device 1. The switching process is a process for switching the magnification of a specimen image by rotating the revolver 14 to move the objectives 13. FIG. 7 shows a process for the case where the magnification of a specimen image switches from the magnification of one of the first to third objectives 13a to 13c to that of the fourth objective 13d. The switching process is performed in response to user operation on the operation unit 17 for rotating the revolver 14 to switch the magnification of a specimen image to that of the fourth objective 13d. The switching process is achieved by the processing unit 19 cooperating with other components of the microscope device 1, based on a program stored in the storage unit 15 and information from the detection unit.

First, the reception unit 191 accepts switching operation on the operation unit 17 for rotating the revolver 14 to switch the magnification of a specimen image (step S11).

Next, the drive control unit 192 controls the drive unit 18 to move the revolver 14 upward, thereby moving the revolver 14 away from the stage 12 (step S12). For example, the drive control unit 192 moves the revolver 14 upward by a predetermined retraction distance to move the objectives 13 away from the specimen surface SF by the retraction distance.

Depending on the shape of the stage 12 or the specimen SP, the interference of an objective 13 may occur at switching the magnification of the specimen image. This is, for example, when there is not a projection in the area where each objective moves relative to the stage during observation but there is a projection in the area where each objective moves to the stage during magnification switching operation (during rotation). To prevent such interference, in step S12 the revolver 14 retracts vertically by electrical operation to move the objectives 13 away from the specimen surface SF by a predetermined retraction distance. The retraction distance may be set to 0. In other words, step S12 may be omitted. Since it may be safe to rotate without retraction, depending on the combination of the working distances of the objectives or the position of the revolver 14, retraction is required only when necessary.

Next, the switch control unit 193 controls the drive unit 18 to switch the magnification of the specimen image (step S13). The switch control unit 193 switches the magnification of the specimen image to that of the fourth objective 13d by rotating the revolver 14 so that the optical axis of the fourth objective 13d is aligned with that of the optical system of the microscope device 1. At this time, the determination unit 195 determines that magnification switching is properly finished, based on information from the detection unit 21. The operation performed by the drive unit 18 in step S13 may be referred to as magnification switching operation. It may also be said that the magnification switching operation is operation for switching the magnification of a specimen image by moving the revolver 14 in a plane perpendicular to the optical axes of the plurality of objectives to change objectives used for observing the specimen among the plurality of objectives.

Next, the drive control unit 192 controls the drive unit 18 to move the revolver 14 downward, thereby moving the fourth objective 13d closer to the stage 12, so that the revolver returns from the retraction position to the original position (step S14). Thereafter, the drive control unit 192 moves the revolver 14 downward by an amount of parfocal correction to move the objectives 13 closer to the specimen surface SF by the amount of parfocal correction (step S15).

More specifically, when the revolver 14 rotates to switch the magnification of the specimen image to that of the fourth objective 13d, the drive control unit 192 performs electrical operation of vertical movement to refocus on a position appropriate for the magnification after the switching, thereby moving the fourth objective 13d closer to the specimen surface SF. At this time, control for parfocal correction is performed on the objective after the switching; the amount of parfocal correction is set to correct a value obtained by adding the actual error for the working distance of the fourth objective 13d to an amount satisfying the inequalities in Expression 3 above (predetermined distance D4).

Next, the focusing unit 194 performs focusing operation (step S16). The focusing operation is a process for adjusting the actual focus position of the fourth objective 13d to the specimen surface SF by moving the revolver 14 vertically in response to user operation on the operation unit 17. It may also be said that the focusing operation is operation for focusing by moving at least one of the revolver 14 and the stage 12 to change the distance between each objective 13 and the specimen surface SF. At this time, the focusing unit 194 moves the stage 12 vertically in the range where the fourth objective 13d does not approach the stage 12 by more than the distance F4 from a predetermined position where the design focus position of the fourth objective 13d coincides with the specimen surface SF. While checking captured images shown on the display terminal 9, a user operates the operation unit 17 to adjust the actual focus position of the fourth objective 13d to the specimen surface SF. At switching from a low-magnification objective to a high-magnification objective, the focus is adjusted manually because the high-magnification objective may be out of focus.

This completes the switching process.

FIG. 7 illustrates a switching process for the case where the magnification of a specimen image switches from the magnification of one of the first to third objectives 13a to 13c to that of the fourth objective 13d. When the magnification of a specimen image switches from the magnification of the fourth objective 13d to that of one of the first to third objectives 13a to 13c, a similar switching process is performed. In this case, the drive control unit 192 performs drive control in step S15 so that the distance between the first to third objectives 13a to 13c having longer working distances and the specimen surface SF increases, based on values that are the actual errors of the working distances of the first to third objectives 13a to 13c added to the predetermined distance D4. However, when this includes unnecessary operation, such as when the destination position coordinates are above the retraction position, part or all of the operation for returning from the retraction position (step S14) may be omitted.

The following modified examples may be applied to the microscope device 1.

In the above embodiment, the drive control unit 192 moves the objectives 13 closer to or away from the specimen surface SF in step S14 of the switching process so that during the switching process they are moved by an amount of parfocal correction based on a value obtained by adding the actual error for the working distance of each objective to the predetermined distance D4. The amount of parfocal correction may be set to a value obtained by adding the actual error to the predetermined distance D4, or may be any amount greater than the amount of correction for correcting this actual error. In some cases, part or all of driving for correcting the actual error is involved in driving for correction by the predetermined distance D4, or part or all of driving for correction by the predetermined distance D4 is involved in driving for correcting the actual error. However, the amount of parfocal correction must not fall below the lower limit of the range of focusing based on the distances F by which the design focus positions of the objectives 13 are movable from the specimen surface SF toward the stage 12, nor exceed the upper limit of the range of focusing that is set in consideration of interference with another component of the microscope device.

In the above embodiment, autofocus operation may be performed after step S14 of the switching process. For example, when contrast-based autofocus is used, after step S14 the focusing unit 194 controls the drive unit 18 to obtain captured images while changing the distance between the objectives 13 and the specimen surface SF. The focusing unit 194 calculates the contrast of each captured image, and sets the stage 12 to where the contrast is high. This facilitates a user's manual focusing operation.

In the above embodiment, only the shoulder of the fourth objective 13d among the objectives 13 is held farther from the specimen surface SF than the shoulders of the other objectives 13a to 13c. The arrangement is not limited to this example; the shoulders of two or more of the plurality of objectives may be held farther than the shoulders of the other objectives. For example, the distances between the shoulders of all the objectives and the specimen surface may differ.

In this case, the objectives 13 are held so that the shoulders of the second to fourth objectives 13b to 13d are farther from the specimen surface by predetermined distances D2 to D4, respectively, than the shoulder of the first objective 13a. The predetermined distance Dn for each objective is set to satisfy the following expression.

$$( En + Fm + h ) - WDn < Dn < WDm - ( Em + Fn + h ) ( n = 2 , 3 , 4 , m < n ) \qquad [ Expression 5 ]$$

In the above embodiment, the lower and upper limits of the predetermined distance D4 are set based on the greater h of the heights of the specimen SP and the specimen holder 121 with respect to the specimen surface SF. The height h is not limited to this example, and may be the height of a portion projecting above the specimen surface SF of any object disposed on the stage 12 in the region facing the objectives 13.

In the above embodiment, the microscope device 1 includes four objectives 13. The number is not limited to this example; the microscope device 1 may include any number of objectives 13 including two objectives 13 having different working distances.

In the above embodiment, the objectives 13 are disposed so that their optical axes are on a circle centered at the axis of rotation of the revolver 14; the revolver 14 rotates to switch the magnification of a specimen image. The arrangement is not limited to this example; the objectives 13 may be disposed at any position along the mounting surface 141. In this case, the revolver 14 may move in a plane perpendicular to the optical axes of the objectives 13 to switch the magnification of a specimen image. For example, the objectives 13 are disposed so that their optical axes are on a straight line; the revolver moves along a straight line perpendicular to the optical axis of each objective 13 to switch the magnification of a specimen image.

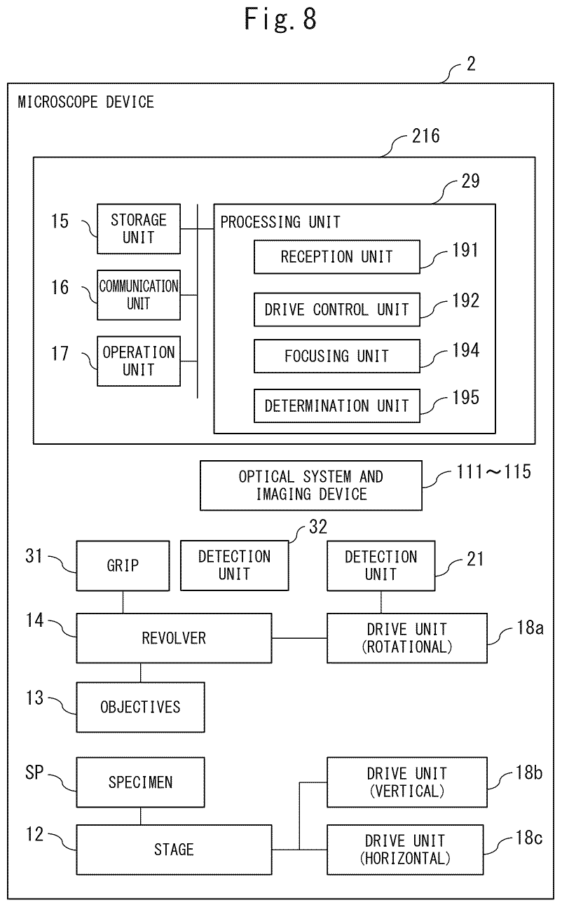

In the above embodiment, the revolver 14 rotates by electrical operation. The revolver 14 is not limited to this example, and may be rotated manually by a user. FIG. 8 is an exemplary functional block diagram of a microscope device 2 of a second embodiment of the present invention. The microscope device 2 differs from the microscope device 1 in that a grip 31 for a user to rotate the revolver 14 manually is included, that the switch control unit 193 is not included in a processing unit 29 of a control unit 216, and that a stage portion is moved vertically to perform focusing operation. In addition to the detection unit 21 may be included a detection unit 32 that detects grasp of the grip 31. The other components of the microscope device 2 are the same as corresponding components of the microscope device 1, and thus are assigned the same reference numerals and omitted from the description.

The detection unit 32 is configured to detect that the grip 31 is grasped for a user to rotate the revolver 14, and includes a sensor. The sensor is, for example, a microswitch or a pressure sensor built in the grip 31. The detection unit 32 generates a signal indicating information as to whether the grip 31 is grasped, and provides the signal to the processing unit 29.

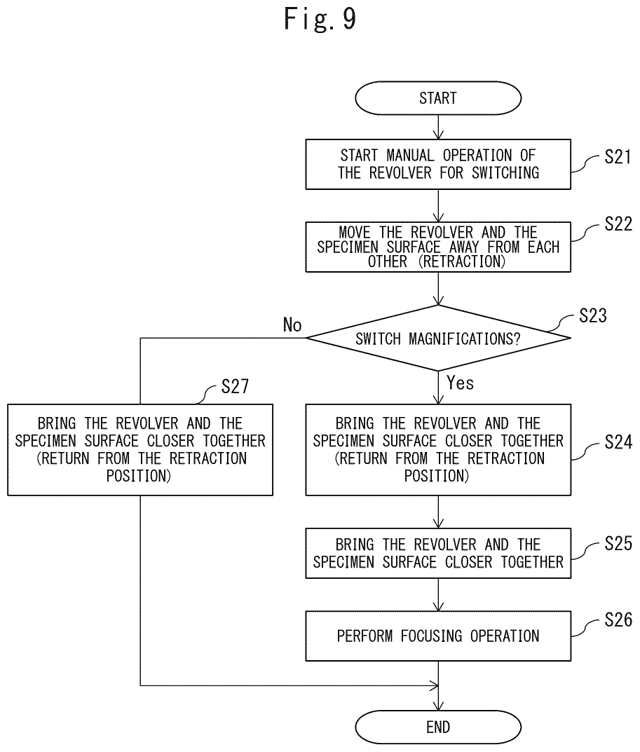

FIG. 9 is a flowchart showing an example of the flow of a switching process performed by the microscope device 2. The switching process is a process for bringing the objectives and a specimen surface closer together when a user's manual operation rotates the revolver 14 to switch the magnification of the specimen image from the magnification of one of the first to third objectives 13a to 13c to that of the fourth objective 13d. The switching process is achieved by the processing unit 29 cooperating with other components of the microscope device 2, based on a program stored in the storage unit 15.

First, the reception unit 191 recognizes that the revolver starts rotating manually, based on information from the detection unit 21, or that a user is about to rotate the revolver, based on information from the detection unit 32 (step S21). Thereafter, the focusing unit controls the drive unit 18 to start the stage 12 moving downward, thereby moving the specimen surface sufficiently away from the revolver (step S22).

The reception unit 191 obtains information for identifying an objective whose optical axis is aligned with the optical axis of the optical system of the microscope device 1 from the detection unit 21, and stores the information in the storage unit 15. The determination unit 195 determines whether the magnification of the specimen image is switched to that of the fourth objective 13d, based on time-series changes in the information stored in the storage unit 15 for identifying an objective whose optical axis is aligned with the optical axis of the optical system of the microscope device 1 (step S23).

When the magnification of the specimen image is not switched to that of the fourth objective 13d (No in step S23), the drive control unit 192 controls the drive unit 18 to start the stage 12 moving upward, thereby returning the stage 12 and the revolver 14 to the positional relationship before the start of the switching process; the switching process is then finished.

When the magnification of the specimen image is switched to that of the fourth objective 13d (Yes in step S23), the drive control unit 192 controls the drive unit 18 to start the stage 12 moving upward, thereby moving the stage 12 closer to the revolver 14 (step S24).

Next, the drive control unit 192 moves the revolver 14 downward by an amount of parfocal correction to move the objectives 13 closer to the specimen surface SF by the amount of parfocal correction, as in step S15 (step S25).

The focusing unit 194 performs focusing operation, as in step S16 (step S26). The focusing operation is a process for adjusting the actual focus position of the fourth objective 13d to the specimen surface SF by moving the revolver 14 vertically in response to user operation on the operation unit 17. This completes the switching process.

As described above, the revolver 14 of the microscope device 2 holds the objectives 13 so that the shoulder of the fourth objective 13d is farther from a specimen surface SF by a predetermined distance D4 than the shoulders of the first to third objectives 13a to 13c. The drive unit 18 brings the revolver 14 and the specimen surface SF closer together, based on the predetermined distance D4, when the magnification of the specimen image switches from the magnification of one of the first to third objectives 13a to 13c to that of the fourth objective 13d. The predetermined distance is set to exceed a lower limit based on the working distance of the fourth objective 13d and to be less than an upper limit based on the working distances of the first to third objectives 13a to 13c so that, in focusing operation for each objective 13, the other objectives do not interfere with a portion projecting from the specimen surface SF on the stage 12. This enables the microscope device 2 to prevent interference between the objectives and the specimen holder or specimen with a simple structure even when the magnification of the specimen is switched by a user's manual operation.

According to the embodiment described above, objectives can be attached to a revolver so that their optical axes are parallel even when an objective whose working distance is not long enough may come into contact with the stage or specimen.

It should be understood that those skilled in the art can make various changes, substitutions, and modifications without departing from the scope of the present invention. For example, the above embodiment and modified examples may be appropriately combined and implemented within the scope of the present invention.

What is claimed is:

1. A microscope device on which a revolver is mountable, the revolver holding a plurality of objectives having different magnifications, the same design value of parfocal distance, and different working distances, so that optical axes of the objectives are parallel,
the microscope device comprising a drive unit configured to perform focusing operation for focusing by moving at least one of the revolver and a stage where the specimen is placed to change the distance between each objective and a specimen surface of the specimen,
the revolver having a recessed structure in which a region where a first objective among the plurality of objectives is held is recessed by a predetermined distance with respect to a region where a second objective different from the first objective is held,
a predetermined distance Db indicating the recessed distance with respect to the region where an objective a corresponding to the second objective among the plurality of objectives is held the region where an object b corresponding to the first objective having a shorter working distance than that of the objective a being set such that the tip of the objective a does not interfere with a specimen holder or a cover member of the specimen on the stage at the focusing operation for the objective b, and that the tip of the objective b does not interfere with the specimen holder or the cover member of the specimen on the stage at the focusing operation for the objective a, and
the predetermined distance satisfies the following conditional expression.
(Eb+Fa+h)−WDb<Db<WDa−(Ea+Fb+h)
where
Eb: the tolerance for the working distance of the objective b
Fa: the distance by which the focus position of the objective a is movable toward the stage beyond the specimen surface in the focusing operation for the objective a
h: the height of the specimen holder or the cover member of the specimen projecting from the specimen surface in a region on the stage facing the objectives
WDb: the working distance of the objective b
WDa: the working distance of the objective a
Ea: the tolerance for the working distance of the objective a
Fb: the distance by which the focus position of the objective b is movable toward the stage beyond the specimen surface in the focusing operation for the objective b.

2. The microscope device according to claim 1, wherein the drive unit is further configured to perform a magnification switching operation for switching the observation magnification of the specimen by moving the revolver in a plane perpendicular to the optical axes to change objectives used for observing the specimen among the plurality of objectives.

3. The microscope device according to claim 2, wherein the predetermined distance is set such that the tip of any one of the plurality of objectives does not interfere with the specimen holder or the cover member of the specimen on the stage at the magnification switching operation.

4. The microscope device according to claim 3, wherein the working distance of the first objective is the shortest of the working distances of the plurality of objectives.

5. The microscope device according to claim 3, wherein the drive unit corrects the distance between the first objective and the specimen surface by an amount of parfocal correction arising from the predetermined distance when the observation magnification of an image of the specimen switches from an observation magnification of the second objective to an observation magnification of the first objective by the magnification switching operation.

6. The microscope device according to claim 3, wherein
the drive unit corrects the distance between the second objective and the specimen surface by an amount of parfocal correction arising from the predetermined distance when the observation magnification of an image of the specimen switches from an observation magnification of the first objective to an observation magnification of the second objective by the magnification switching operation.

7. The microscope device according to claim 4, wherein
the drive unit
makes a correction by an amount of parfocal correction arising from the predetermined distance by adjusting the positional relationship between the revolver and the stage, at the magnification switching operation for switching objectives used for observing the specimen from the first objective to the second objective, so that the distance between the second objective and the specimen surface after the switching is less than the distance before the switching, and
make a correction by an amount of parfocal correction arising from the predetermined distance by adjusting the positional relationship between the revolver and the stage, at the magnification switching operation for switching objectives used for observing the specimen from the second objective to the first objective, so that the distance between the first objective and the specimen surface after the switching is greater than the distance before the switching.

8. A flat revolver mountable on a microscope device and configured to hold a plurality of objectives having different magnifications, the same design value of parfocal distance, and different working distances, so that optical axes of the objectives are parallel,
the flat revolver having a recessed structure in which, with respect to a region where an objective a among the plurality of objectives is held, a region where an objective b different from the objective a and having shorter working distance than that of the objective a among the plurality of objectives is held is recessed by a predetermined distance Db such that, at focusing operation of a drive unit of the microscope device for focusing an object of observation for the objective b by moving at least one of the flat revolver and a stage where the specimen is placed to change the distance between each objective and a specimen surface of the specimen, the tip of the objective a does not interfere with a specimen holder or a cover member of the specimen on a stage of the microscope device, and that, at focusing operation of a drive unit of the microscope device for focusing an object of observation for the objective a, the tip of the objective b does not interfere with a specimen holder or a cover member of the specimen on a stage of the microscope device, and
the predetermined distance Db satisfies the following conditional expression.
(Eb+Fa+h)−WDb<Db<WDa−(Ea+Fb+h)
where
Eb: the tolerance for the working distance of the objective b
Fa: the distance by which the focus position of the objective a is movable toward the stage beyond the specimen surface in the focusing operation for the objective a
h: the height of the specimen holder or the cover member of the specimen projecting from the specimen surface in a region on the stage facing the objectives
WDb: the working distance of the objective b
WDa: the working distance of the objective a
Ea: the tolerance for the working distance of the objective a
Fb: the distance by which the focus position of the objective b is movable toward the stage beyond the specimen surface in the focusing operation for the objective b.

9. The flat revolver according to claim 8, wherein the drive unit is further configured to perform a magnification switching operation for switching the observation magnification of the specimen by moving the revolver in a plane perpendicular to the optical axes to change objectives used for observing the specimen among the plurality of objectives.

10. The flat revolver according to claim 9, wherein the predetermined distance is set such that the tip of any one of the plurality of objectives does not interfere with the specimen holder or the cover member of the specimen on the stage at the magnification switching operation.
